(19) United States
(12) Patent Application Publication
(10) Pub. No.: US 2015/0377472 A1
(43) Pub. Date: Dec. 31, 2015

(54) OVERMOLDED REPLACEABLE LIGHT EMITTING DIODE LAMP

(71) Applicant: General Electric Company, Schenectady, NY (US)

(72) Inventors: Peter Almosdi, Budapest (HU); Gyorgy Szabo, Budapest (HU); Peter Zalka, Budapest (HU); Krisztian Novak, Budapest (HU)

(21) Appl. No.: 14/318,229

(22) Filed: Jun. 27, 2014

(51) Int. Cl. F21V 29/71; B29C 45/14; F21V 23/06; F21K 99/00; F21V 23/00; F21V 5/04

(52) U.S. Cl. CPC F21V 29/713; F21V 23/009; F21V 5/04; F21V 23/06; F21K 9/1355; B29C 45/14778; F21Y 2101/02

(57) ABSTRACT

Provided is an overmolded replaceable, light emitting diode (LED) lamp that includes a light engine having an LED chip mounted thereon and configured to generate and emit light, driver electronics in communication with the light engine, and configured to supply energy to the light engine for generating the light, and one or more connecting portions disposed within a base surface of the LED lamp configured to connect the LED lamp to a connection receiving portion of an external light device for operation thereof. The light engine, the driver electronics and the one or more connecting portions are overmolded by an overmolding material comprising a thermally conductive polymer material which forms a structural component of the LED lamp, and mechanically and electrically connects the light engine, the driver electronics and the one or more connecting portions together.

### I. TECHNICAL FIELD

The technical field relates generally to a replaceable light emitting diode (LED) lamp.

### II. BACKGROUND

Light emitting diode (LED) replacement lamps are used as replacements for traditional light sources such as incandescent lamps, fluorescent lamps and halogen lamps. An LED is a semiconductor device that emits a narrow-spectrum of light when electrically biased. A high powered LED light device generates a large amount of unwanted heat which may cause damage or performance degradation if not removed.

FIG. 1 is a schematic illustration of a conventional LED replaceable lamp 1, having a housing 2 comprising driver electronics 3 therein and pins 4 connected at a base surface, for operating of the LED replaceable lamp 1, the housing 2 further includes potting material 6 surrounding the driver electronics 3, and an insulation cover 8 at a top surface of the driver electronics 3. The LED replaceable lamp 1 further includes a heat sink 10 for dissipating the heat generated from a LED light device (not shown) and the driver and a lens (not shown) covering the LED device for directing the light emitted therefrom.

The LED replaceable lamp 1 includes multiple fastening components needed to assemble the housing 2, the driver electronics 3, the pins 4, the insulation cover 8, the heat sink 10, and the lens. Thus, numerous plastic components that require tooling and precise fastening dimensioning are necessary along with increased costs associated with the heat sink 10.

### III. SUMMARY OF THE EMBODIMENTS

The various embodiments of the present disclosure are configured to mitigate the disadvantages of the above-mentioned replaceable LED lamp by providing an overmolded replaceable LED lamp which eliminates some of the components and fastening means required by the conventional replaceable LED lamp, and therefore decreases manufacturing costs, increases productivity while maintaining or improving mechanical rigidity, overall strength, and thermal performance.

In one exemplary embodiment, an overmolded replaceable, light emitting diode (LED) lamp is provided that includes a light engine comprising at least one LED having an LED chip mounted thereon and configured to generate and emit light, driver electronics in communication with the lightlight engine, and configured to supply energy to the light engine for generating the light, and one or more connecting portions disposed within a base surface of the LED lamp configured to connect the LED lamp to a connection receiving portion of an external light device (e.g. fitting, fixture, or socket) for operation thereof. The light engine, the driver electronics and the one or more connecting portions are overmolded by an overmolding material comprising a thermally conductive moldable substrate (e.g. polymers, cements) material which forms a structural component of the LED lamp, and mechanically and electrically connects the light engine, the driver electronics and the one or more connection portions together.

In another exemplary embodiment, a method of forming an overmolded replaceable light emitting diode (LED) lamp is provided, and includes inserting at least two components of the LED lamp including driver electronics, a light engine, and one or more connecting portions of the LED lamp, a heat sink, within a mold cavity, and injecting the mold cavity with an overmolding material comprising a thermally conductive polymer material to encapsulate the at least two components of the LED lamp, thereby forming a structural component of the LED lamp, and mechanically and electrically connecting the at least two components together, for operation of the LED lamp.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### IV. DESCRIPTION OF THE DRAWINGS

FIG. 1 is a schematic illustration of a conventional replaceable light emitting diode (LED) lamp.

FIG. 2 is a schematic illustration of an overmolded replaceable LED lamp according to one or more exemplary embodiments.

FIG. 3 is an exploded illustration of the overmolded replaceable LED lamp of FIG. 1 according to one or more exemplary embodiments.

FIG. 4 is an exploded illustration of an overmolded replaceable LED lamp having a separately overmolded heat sink according to one or more other exemplary embodiments.

FIG. 5 is an exploded illustration of an overmolded replaceable LED lamp having overmolded combined heat sink and light engine, and separately overmolded combined housing and connecting portions, according to one or more exemplary embodiments.

FIG. 6 is an exploded illustration of an overmolded replaceable LED lamp having an overmolded combined housing and heat sink according to one or more other exemplary embodiments.

FIG. 7 is a flow diagram of an exemplary method for performing an overmolded operation of an overmolded replaceable LED lamp according to one or more exemplary embodiments.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### V. DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

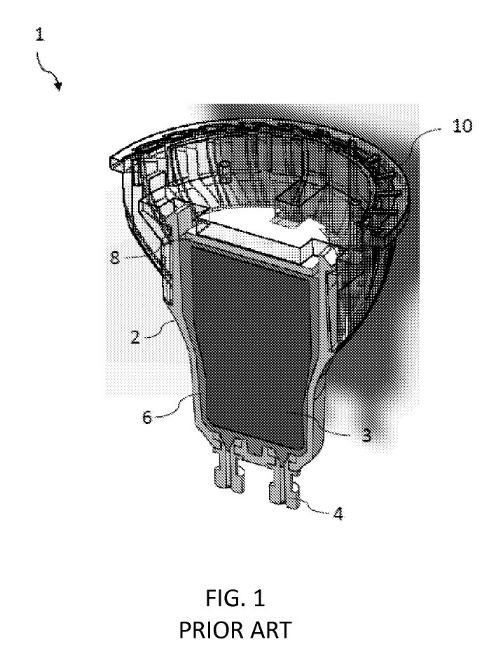

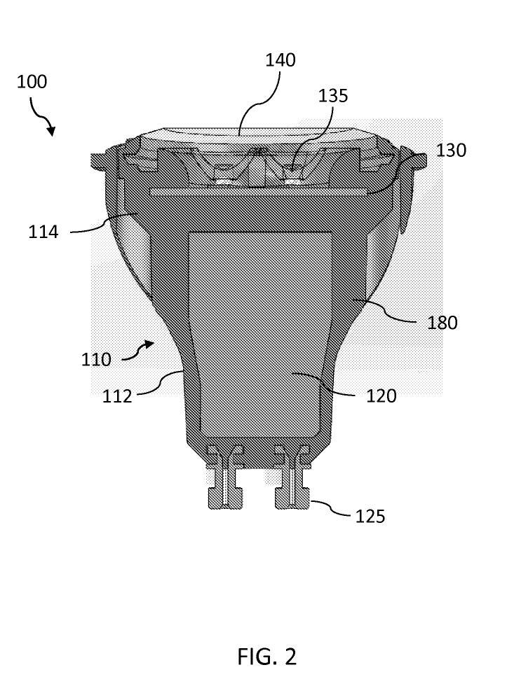

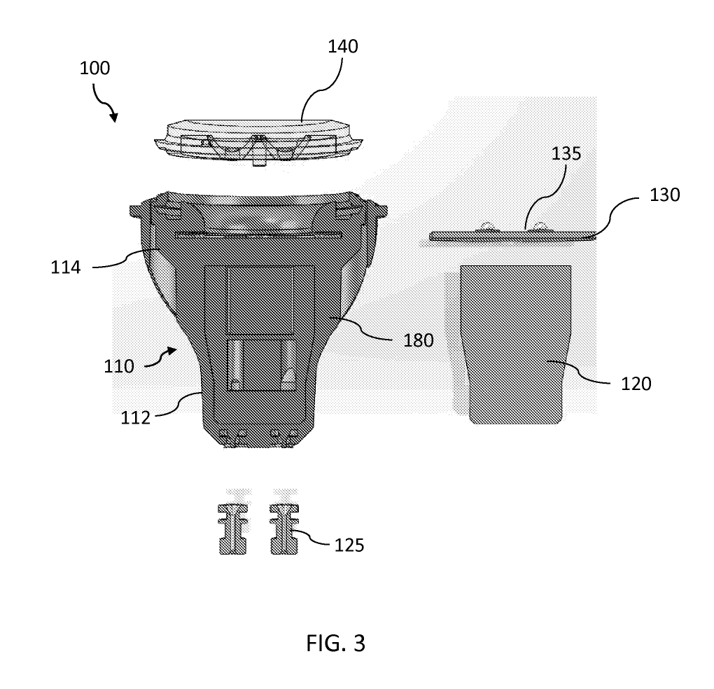

FIG. 2 is a schematic illustration of an overmolded replaceable LED lamp 100 configured to generate and emit light therefrom, to be used as a replacement light within various lighting products, such as lamps and other lighting fixtures. FIG. 3 is an exploded illustration of the overmolded replaceable LED lamp 100 as shown in FIG. 1.

Now referencing FIGS. 2 and 3, the overmolded replaceable LED lamp 100 comprises a housing 110 including a base portion 112, a heat sink 114, driver electronics 120, connecting portions (e.g., pins, electrical connectors) 125 all combined as one continuous solid, as well as a light engine 130 having an LED chip 135 mounted (in FIG. 2.) thereon or overmolded thereinto (in FIG. 3.) and an optic lens 140 at the top surface of the LED lamp 100.

According to one or more embodiments, the housing 110 includes the base portion 112 and the heat sink 114, and is formed by placing the driver electronics 120, the connecting portions 125, optionally the light engine 130 including the LED chips 135 and optionally a heat spreader 500 within a mold cavity. The mold cavity is then injected with an overmolding material 180 e.g., a thermally-conductive thermoplastic or thermoset material, which is configured to physically and mechanically bind the components (i.e., the heat sink 114, the driver electronics 120, the connecting portions 125, the light engine 130 and LED chip 135) together. This single overmolding process eliminates the need for additional fastening components for fastening the components together. The overmolding material 180 forms an outer surface of the housing 110 thereby forming the outer surface and appearance of the LED lamp 100. According to one or more embodiments, the thermal conductivity of the solidified overmolding material 180 is greater than 0.6 W/mK.

Regarding the formation of the housing 110, the base portion 112 is formed by the overmolding material 180 surrounding the driver electronics 120, and is integrally combined with the connecting portions 125, to form the housing 110. The heat sink 114 is further mechanically combined with the driver electronics 120 and the base portion 112.

According to one exemplary embodiment, operation of the LED lamp 100 will now be discussed with reference to FIG. 1, the driver electronics 120 are configured to operate the LED lamp 100, by supplying energy to the light engine 130 having the LED chip mounted thereon in electrical communication with the driver electronics 120. The LED lamp 100 is therefore configured to produce and emit light when a mechanical connection and an electrical connection is completed between the connecting portions 125 and an external connector receiving portion (not shown) of a lighting device. The heat sink 114 is disposed around the light engine 130 and is configured to dissipate heat generated therefrom. The optic lens 140 disposed at a top surface of the LED chip 135 is configured to direct light emitted from the LED chip 135.

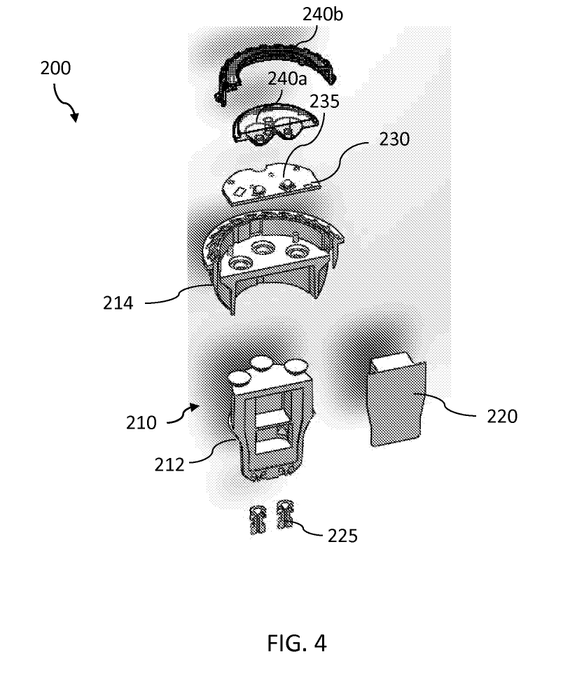

The present invention is not limited to the overmolding of the heat sink 114 and the housing 110 including the driver electronics 120 together in a single overmolding process. Other overmolding processes may be performed to form an overmolded replaceable LED lamp in accordance with other embodiments of the present invention as shown in FIGS. 4, 5 and 6 discussed below.

FIG. 4 is an exploded illustration of an overmolded replaceable LED lamp 200 having a separately overmolded heat sink 214 according to one or more other exemplary embodiments. The overmolded replaceable LED lamp 200 includes similar components as that of the LED lamp 100 therefore a detailed description of each component has been omitted.

The LED lamp 200 comprises a housing 210 having a base portion 212 and a driver electronics 220 disposed therein and connecting portions 225 at a bottom surface of the housing 210. In this exemplary embodiment, the housing 210, the base portion 212, the driver electronics 220 and the connecting portions 225 are binded together via the overmolding material 180. The heat sink 214 is overmolded separately and then connected with the housing 210 to form the outer surface of the LED lamp 200.

A light engine 230 and an LED chip 235 are then combined with the overmolded heat sink 214 and an optic lens 240a and lens cover 240b is disposed at a top surface of the LED lamp for directing the light emitted therefrom. The overmolded process performed to produce the LED lamp 200 is a two-step process requiring a step for overmolding the base portion 212 including the driver electronics 220 and the connecting portions 225, and a second step for separately overmolding the heat sink 214 and combining with the overmolded base portion 212.

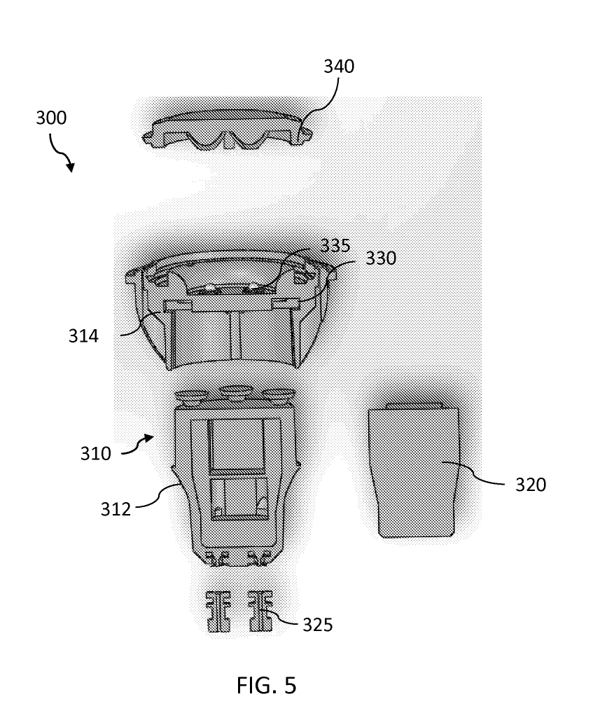

FIG. 5 is an exploded illustration of an overmolded replaceable LED lamp 300 of yet another embodiment of the present invention. As shown in FIG. 5, the LED lamp 300 comprises similar components as that of the LED lamp 100 and LED lamp 200 shown in FIGS. 1 and 2, therefore a detailed description of the operation of each component is omitted.

The LED lamp 300 comprises a housing 310 having a base portion 312 including a driver electronics 320 to be disposed therein and connecting portions 325 at a bottom surface of the housing 310. The housing 310 including the driver electronics 320 and the connecting portions 325 within the base portion 312 is binded together using the overmolding material 180.

A heat sink 314 and a light engine 330 having an LED chip 335 mounted thereon, are overmolded together using the overmolding material 180 in separate consecutive overmolding process steps with the overmolded housing 310 including the base portion 312. The overmolded housing 310 and the overmolded heat sink 314 are combined together in separate overmolding processes, according to one or more other exemplary embodiments. The two components can be combined by numerous methods, e.g. the use of a mechanical fastening component, or adhesives, or by overmolding either component into the other component acting as an insert in a mold cavity, such as in FIG. 4 and FIG. 5, or melting the two parts together, or snap-in fitting. An optic lens 340 is disposed at a top surface of the LED lamp 300 for directing the light emitted therefrom

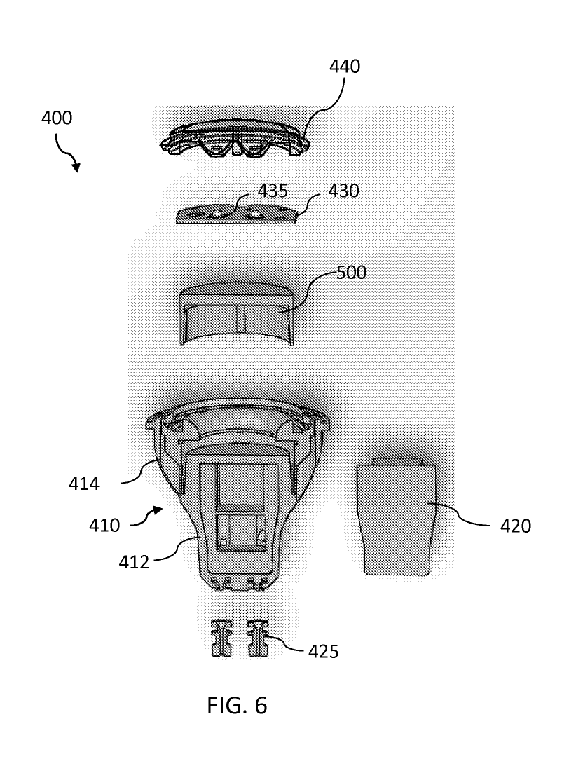

In yet another exemplary embodiment, as shown in FIG. 6, an overmolded replaceable LED lamp 400. The components of the LED lamp 400 are similar to the components of the LED lamps 100, 200 and 300 as shown in FIGS. 1, 2 and 3 and therefore a detailed description of the operation thereof is omitted. The LED lamp 400 comprises a housing 410 including a base portion 412 and a heat sink 414 integrally combined together to form an outer surface and appearance of the LED lamp 400. The housing 210 further comprises a driver electronics 420 and connecting portions 425 within the base portion 412 for facilitating operation of the LED lamp 400.

A light engine 430 including an LED chip 435 may then be mounted on the overmolded housing 210 and heat sink 214 combined, and an optic lens 440 may then be disposed over the light engine 430 to direct light emitted therefrom. An optional heat spreader 500 may also be provided. The heat spreader 500 is mounted between the light engine 430 and the heat sink 414, and is configured to further conduct heat away and cool the light engine 430 and LED chip 435 mounted thereon along with the driver electronics. The heat spreader 500 may be formed a metal e.g., aluminum or other suitable metal for the purpose set forth herein.

The embodiments of the present invention provide an overmolded replaceable LED lamp which may be formed with limited essential components e.g., driver electronics, connecting portions, and a light engine having an LED chip mounted thereon, for operating of the LED lamp. The essential components being inserted within a mold cavity and injected with an overmolding material to form a single body of the LED lamp which provides mechanical i.e., structural connection, and electrical connection between the essential components, a thermal conductivity as desired, and an outer aesthetic appearance of the LED lamp. As discussed above with reference to FIGS. 1 through 6, the components may be combined in different ways, e.g., overmolded together as a single unit, one or more components overmolded together and then combined with other of the components which are separately overmolded.

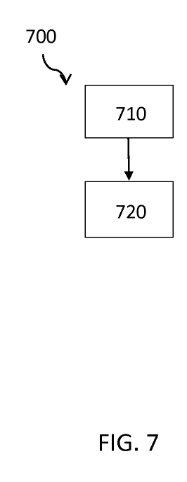

FIG. 7 is a flow diagram of an exemplary method 700 for performing an overmolding process of the overmolded replaceable LED lamps 100, 200, 300 and 400 of FIGS. 1 through 6 according to one or more exemplary embodiments. In step 710, the desired components (e.g., the light engine and LED chip, the driver electronics and the connecting portions) are inserted within a mold cavity. Thus, in step 710 at least two components of the LED lamp are inserted into the mold cavity. The two components may include any two of the driver electronics, a light engine, and one or more connecting portions of the LED lamp, a heat sink, within a mold cavity.

In step 720, an overmolding material is then injected into the mold cavity to encapsulate and combine the desired components together as a single unit. The overmolding material encapsulates the components thereby serving both a thermal management purpose and a mechanical fastening purpose. The overmolding material further provides an outer surface and aesthetic appearance of the LED lamp. The overmolding material is a thermally conductive polymer material.

According to an alternative embodiment, in step 710, the desired components may include the driver electronics, the connecting portions, the heat sink and the light engine and LED chip of the LED lamp.

In yet another embodiment, in step 720, the desired components may include the driver electronics and the connecting portions to be overmolded together, and the heat sink and light engine to be overmolded together, and then combined.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An overmolded replaceable, light emitting diode (LED) lamp comprising:
a light engine having an LED chip mounted thereon and configured to generate and emit light;
driver electronics in communication with the light engine, and configured to supply energy to the light engine for generating the light; and
one or more connecting portions disposed within a base surface of the LED lamp configured to electrically connect and mechanically fasten and orient the LED lamp to a connection receiving portion of an external light device for operation thereof,
wherein the light engine, the driver electronics and the one or more connecting portions being overmolded by an overmolding material comprising a thermally conductive polymer material which forms a structural component of the LED lamp, and mechanically and electrically connects the light engine, the driver electronics and the one or more connecting portions together.

2. The LED lamp of claim 1, further comprising:
a housing comprising:
a base portion including the driver electronics and the one or more connecting portions; and
a heat sink combined with the base portion and configured to dissipate heat from the light engine and the driver electronics, wherein the light engine, the heat sink, the driver electronics and the one or more connecting portions are overmolded together using the overmolded material to form the structural component of the LED lamp.

3. The LED lamp of claim 1, further comprising:
a housing comprising a base portion including the driver electronics and the one or more connecting portions; and
a heat sink connected with the housing and configured to dissipate heat from the light engine, wherein the heat sink is separately overmolded using the overmolded material, from the driver electronics and the one or more connecting portions overmolded together using the overmolded material, and combined to form the structural component of the LED lamp

4. The LED lamp of claim 3, wherein the heat sink and the light engine are overmolded together separately from the driver electronics and the one or more connecting portions, and subsequently combined together, to form the structural component of the LED lamp.

5. The LED lamp of claim 2, further comprising a heat spreader disposed between the heat sink and the light engine to further facilitate dissipation of heat from the light engine.

6. The LED lamp of claim 1, further comprising:
an optic lens disposed at a top surface of the LED chip and configured to direct light emitted from the LED chip.

7. The LED lamp of claim 1, wherein the overmolding material is a thermally conductive polymer material.

8. The LED lamp of claim 7, wherein the overmolding material comprises a thermal conductivity of greater than 0.6 (W/mK).

9. The LED lamp of claim 5, wherein the heat spreader is formed of an aluminum material.

10. A method of forming an overmolded replaceable light emitting diode (LED) lamp, the method comprising:
inserting at least two components of the LED lamp including driver electronics, a light engine, and one or more connecting portions of the LED lamp, a heat sink, within a mold cavity; and
injecting the mold cavity with an overmolding material comprising a thermally conductive polymer material to encapsulate the at least two components of the LED lamp, thereby forming a structural component of the LED lamp, and connecting the at least two components together, for operation of the LED lamp.

11. The method of claim 10, wherein the at least two components comprises the driver electronics, the light engine and the one or more connecting portions.

12. The method of claim 10, wherein the at least two components comprises the heat sink and the light engine.

13. The method of claim 10, wherein the at least two components comprises the driver electronics and the one or more connecting portions overmolded together and the heat sink and the light engine overmolded together.

14. The method of claim 10, wherein the overmolding material is a thermally conductive polymer material having a thermal conductivity greater than 0.6 (W/mk).

15. The method of claim 10, further comprising:
disposing a heat spreader disposed between the heat sink and the light engine to further facilitate dissipation of heat from the light engine.

16. The method of claim 10, further comprising:
disposing an optic lens at a top surface of the LED chip and configured to direct light emitted from the LED chip.
